(19) United States
(12) Patent Application Publication
(10) Pub. No.: US 2026/0301223 A1
(43) Pub. Date: Oct. 1, 2026

(54) THREE DIMENSIONAL POSITION ESTIMATION DEVICE, THREE DIMENSIONAL POSITION ESTIMATION METHOD, AND THREE DIMENSIONAL POSITION ESTIMATION PROGRAM

(71) Applicant: NTT, Inc., Tokyo (JP)

(72) Inventors: Masahiko TSUJI, Musashino-shi (JP); Takahiro MATSUMOTO, Musashino-shi (JP); Taiga YOSHIDA, Musashino-shi (JP); Hiroshi CHIGIRA, Musashino-shi (JP)

(73) Assignee: NTT, Inc., Tokyo (JP)

(21) Appl. No.: 19/480,393

(22) PCT Filed: May 29, 2023
(86) PCT No.: PCT/JP2023/019974

§ 371 Date: Oct. 31, 2025

(51) Int. Cl. G06T 7/73; G06T 3/067

(52) U.S. Cl. CPC G06T 7/75; G06T 3/067

(57) ABSTRACT

A three dimensional position estimation device includes a photographic image/three dimensional point cloud correspondence point estimation unit that receives, as inputs, photographic image information of one photographic image, image feature points of the photographic image, image features of the image feature points, and three dimensional point cloud information regarding a three dimensional point cloud related to the photographic image, and estimates three dimensional positions of the image features on the basis of the photographic image information, the image feature points, the image features, and the three dimensional point cloud information.

### TECHNICAL FIELD

The present invention relates to a three dimensional position estimation device, a three dimensional position estimation method, and a three dimensional position estimation program.

### BACKGROUND ART

In the field of three-dimensional measurement of a subject and the like, there is a technology for estimating a three-dimensional position of image features of an imaged target from two or more photographs.

In this technology, image features of two or more photographic images in which the imaged target is captured are detected, and the correspondence points between the images are estimated through feature matching. The three-dimensional coordinate positions of the image features are estimated using the correspondence points and information regarding the imaging position and orientation of each photographic image.

### CITATION LIST

### Patent Literature

Patent Literature 1: JP 2014-52977 A

### SUMMARY OF INVENTION

### Technical Problem

In the conventional technology for estimating the three-dimensional positions of the image features, it is necessary to prepare at least two or more photographs in which the same portion is imaged from different imaging positions and orientations.

The present invention has been made in view of the above circumstances, and an object thereof is to provide a technology for estimating three-dimensional positions of image features without requiring two or more photographs.

### Solution to Problem

According to an aspect of the present invention, there is provided a three dimensional position estimation device that estimates three dimensional positions of image features which are correspondence points of a three dimensional point cloud with respect to image feature points of a photographic image. The three dimensional position estimation device includes a photographic image/three dimensional point cloud correspondence point estimation unit that receives, as inputs, photographic image information of one photographic image, image feature points of the photographic image, image features of the image feature points, and three dimensional point cloud information regarding a three dimensional point cloud related to the photographic image, and estimates three dimensional positions of the image features on the basis of the photographic image information, the image feature points, the image features, and the three dimensional point cloud information.

According to another aspect of the present invention, there is provided a three dimensional position estimation method for estimating three dimensional positions of image features which are correspondence points of a three dimensional point cloud with respect to image feature points of a photographic image. A first three dimensional position estimation method includes: a step of receiving, as inputs, photographic image information of one photographic image, image feature points of the photographic image, image features of the image feature points, and three dimensional point cloud information regarding a three dimensional point cloud related to the photographic image; a step of generating a virtual camera image obtained by projecting the three dimensional point cloud; and a step of estimating three dimensional positions of the image features by associating a pixel of the photographic image with a pixel of the virtual camera image at the same position as that of the pixel of the photographic image.

A second three dimensional position estimation method includes: a step of receiving, as inputs, photographic image information of one photographic image, image feature points of the photographic image, image features of the image feature points, and three dimensional point cloud information regarding a three dimensional point cloud related to the photographic image; a step of generating a virtual camera with the same position and orientation as a position and orientation of a camera that captures the photographic image in a three dimensional point cloud space, and drawing a virtual camera screen showing the three dimensional point cloud space with the virtual camera; a step of estimating correspondence pixels of the photographic image and the virtual camera screen; and a step of estimating three dimensional positions of the image features by associating a pixel of the photographic image with the three dimensional point cloud present in a pixel of the virtual camera screen at the same position as that of the pixel of the photographic image.

According to still another aspect of the present invention, there is provided a three dimensional position estimation program for estimating three dimensional positions of image features from correspondence points of a three dimensional point cloud with respect to image feature points of a photographic image. The three dimensional position estimation program causes a computer including a processor and a storage device to execute at least some of functions of components of the three dimensional position estimation device.

### Advantageous Effects of Invention

According to the present invention, a technology for estimating the three-dimensional positions of the image features without requiring two or more photographs is provided.

### BRIEF DESCRIPTION OF DRAWINGS

FIG. 1 is a block diagram illustrating a functional configuration of a three-dimensional position estimation device according to an embodiment.

FIG. 2 is a flowchart illustrating a flow of processing executed by a three-dimensional position estimation device according to the embodiment.

FIG. 3 is a block diagram illustrating a functional configuration of a three-dimensional position estimation device including a photographic image/three-dimensional point cloud correspondence point estimation unit according to a first configuration example.

FIG. 4 is a flowchart illustrating a flow of processing executed by a photographic image/three-dimensional point cloud correspondence point estimation unit according to the first configuration example.

FIG. 5 is a diagram schematically illustrating a concept of processing executed by a photographic image/three-dimensional point cloud correspondence point estimation unit according to the first configuration example.

FIG. 6 is a block diagram illustrating a functional configuration of a three-dimensional position estimation device including a photographic image/three-dimensional point cloud correspondence point estimation unit according to a second configuration example.

FIG. 7 is a flowchart illustrating a flow of processing executed by a photographic image/three-dimensional point cloud correspondence point estimation unit according to the second configuration example.

FIG. 8 is a diagram schematically illustrating a concept of processing executed by a photographic image/three-dimensional point cloud correspondence point estimation unit according to the second configuration example.

FIG. 9 is a diagram schematically illustrating optimum correspondence point determination processing executed by a photographic image/three-dimensional point cloud correspondence point estimation unit.

FIG. 10 is a diagram schematically illustrating processing of removing hidden points from a virtual camera viewpoint, which is executed by a photographic image/three-dimensional point cloud correspondence point estimation unit.

FIG. 11 is a diagram schematically illustrating processing of removing hidden points from a virtual camera viewpoint, which is executed by a photographic image/three-dimensional point cloud correspondence point estimation unit.

FIG. 12 is a block diagram illustrating a hardware configuration of a three-dimensional position estimation device according to the embodiment.

### DESCRIPTION OF EMBODIMENTS

Hereinafter, an embodiment according to the present invention will be described with reference to the drawings.

### (Basic Functional Configuration)

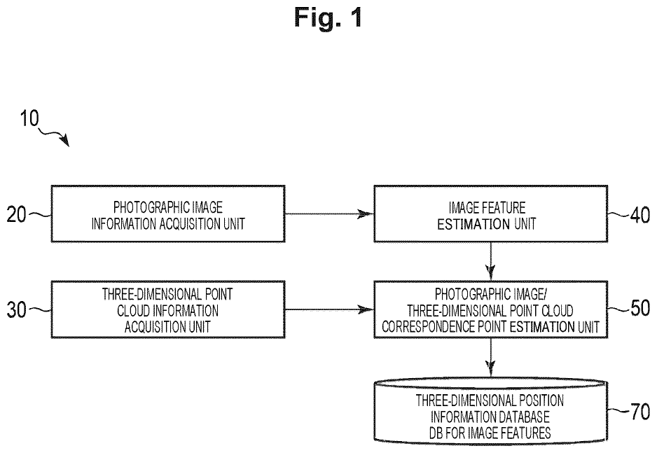

First, a basic functional configuration of a three-dimensional position estimation device 10 according to an embodiment will be described with reference to FIG. 1. FIG. 1 is a block diagram illustrating a basic functional configuration of the three-dimensional position estimation device 10 according to the embodiment. The three-dimensional position estimation device 10 according to the embodiment is a device that estimates a three-dimensional coordinate position corresponding to a pixel at an image feature point of a photographic image from photographic image information of one photographic image and a three-dimensional point cloud which is data of a set of points in a three-dimensional space.

The three-dimensional position estimation device 10 includes a photographic image information acquisition unit 20, a three-dimensional point cloud information acquisition unit 30, an image feature estimation unit 40, a photographic image/three-dimensional point cloud correspondence point estimation unit 50, and a three-dimensional position information database (DB) 70 for image features.

The photographic image information acquisition unit 20 acquires photographic image information for one photographic image. The photographic image information is provided from the outside. The photographic image information includes a camera model, internal parameters, and external parameters for a camera that captures the photographic image. The camera model represents where the three-dimensional space is projected onto the photographic image plane. For example, the camera model includes a pinhole camera model. The internal parameters are parameters representing characteristics of an optical system of the camera. The internal parameters are used for image correction, distortion correction, and the like. For example, the internal parameters include a focal length, an optical center, and an aspect ratio. The external parameters are parameters representing the position and orientation of the camera. For example, the external parameters include a camera's position, a camera's orientation, and a camera's tilt. The photographic image information acquisition unit 20 transmits the photographic image information to the image feature estimation unit 40. Hereinafter, a camera model for a camera is also simply referred to as a camera.

The three-dimensional point cloud information acquisition unit 30 acquires three-dimensional point cloud information. The three-dimensional point cloud information is data of a set of points in a three-dimensional space related to the photographic image. The three-dimensional point cloud information is provided from the outside. The three-dimensional point cloud information includes three-dimensional origin information of the point cloud. The three-dimensional point cloud information has been calibrated with the external parameters of the photographic image information. That is, the position and orientation of the camera that has captured the photographic image in the three-dimensional space of the point cloud can be known. The three-dimensional point cloud information acquisition unit 30 transmits the three-dimensional point cloud information to the photographic image/three-dimensional point cloud correspondence point estimation unit 50.

The image feature estimation unit 40 estimates the image feature points of the photographic image and the image features of the image feature points on the basis of the photographic image information received from the photographic image information acquisition unit 20. The image feature point is a point representing a conspicuous portion in the image. The image features are used for image processing, pattern recognition, and the like. For example, the image features include color, shape, and texture. The image feature points and the image features may be estimated using Scale-Invariant Feature Transform (SIFT), Accelerated-KAZE (AKAZE), or the like, or may be extracted by deep learning. The image feature estimation unit 40 transmits the estimated image feature points and image features together with the camera model, internal parameters, and external parameters for the camera to the photographic image/three-dimensional point cloud correspondence point estimation unit 50.

The photographic image/three-dimensional point cloud correspondence point estimation unit 50 generates the virtual camera viewpoint and the virtual camera in the three-dimensional point cloud space according to the camera model, external parameters, and internal parameters for the camera. The virtual camera viewpoint includes information regarding the position, orientation, and field of view of the virtual camera. Moreover, the photographic image/three-dimensional point cloud correspondence point estimation unit 50 estimates the points of the three-dimensional point cloud corresponding to the image feature points of the two-dimensional screen coordinates of the virtual camera. In other words, the photographic image/three-dimensional point cloud correspondence point estimation unit 50 estimates the three-dimensional positions of the image features of the photographic image. Thus, the photographic image/three-dimensional point cloud correspondence point estimation unit 50 associates the original photographic image with the three-dimensional point cloud. A specific association method will be described later. At this time, it is preferable to reduce erroneous association. As a method for reducing erroneous association, a method for setting the centroid position of a point nearest of N points as an optimum correspondence point may be used, or a method for determining and removing a three-dimensional point cloud that cannot be seen from the virtual camera may be used. A specific method will be described later. The photographic image/three-dimensional point cloud correspondence point estimation unit 50 transmits the three-dimensional position information of the correspondence points of the three-dimensional point cloud with respect to the image feature points of the photographic image to the three-dimensional position information DB 70 for image features together with the image features.

The three-dimensional position information DB 70 for image features stores three-dimensional position information of the image features of the photographic image, that is, the three-dimensional position information of the correspondence points of the three-dimensional point cloud with respect to the image feature points of the photographic image and the image features.

### (Basic Operation)

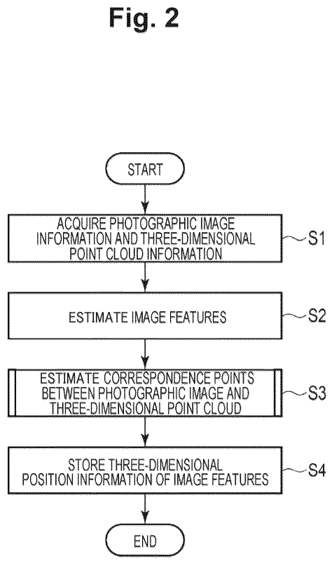

Next, the basic operation of the three-dimensional position estimation device 10 according to the embodiment will be described with reference to FIG. 2. FIG. 2 is a flowchart illustrating a flow of processing executed by the three-dimensional position estimation device 10 according to the embodiment.

In step S1, the photographic image information acquisition unit 20 acquires photographic image information for one photographic image. Details of the photographic image information are as described above. Furthermore, the three-dimensional point cloud information acquisition unit 30 acquires the three-dimensional point cloud information.

In step S2, the image feature estimation unit 40 receives the photographic image information from the photographic image information acquisition unit 20 as an input, and estimates the image feature points of the photographic image and the image features of the image feature points on the basis of the photographic image information. Details of the image feature points and the image features are as described above.

In step S3, the photographic image/three-dimensional point cloud correspondence point estimation unit 50 receives the three-dimensional point cloud information from the three-dimensional point cloud information acquisition unit 30 as an input, receives the image feature points and the image features from the image feature estimation unit 40 as an input, and estimates the correspondence points between the photographic image and the three-dimensional point cloud. Specifically, the photographic image/three-dimensional point cloud correspondence point estimation unit 50 estimates the three-dimensional positions of the correspondence points of the three-dimensional point cloud with respect to the image feature points of the photographic image. In other words, the photographic image/three-dimensional point cloud correspondence point estimation unit 50 estimates the three-dimensional positions of the image features of the photographic image. Details of the estimation of the three-dimensional positions of the correspondence points of the three-dimensional point cloud with respect to the image feature points of the photographic image will be described later.

In step S4, the three-dimensional position information DB 70 for image features receives, from the photographic image/three-dimensional point cloud correspondence point estimation unit 50, three-dimensional position information of the image features of the photographic image, that is, the three-dimensional position information of the correspondence points of the three-dimensional point cloud with respect to the image feature points of the photographic image and the image features and stores the received three-dimensional position information and image features.

### (First Configuration Example of Photographic Image/Three-Dimensional Point Cloud Correspondence Point Estimation Unit 50)

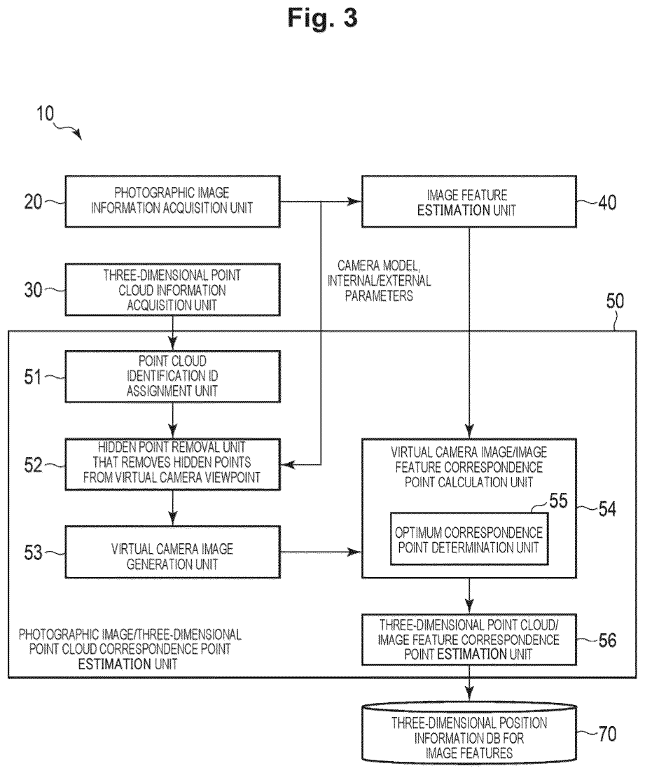

Next, a first configuration example of the photographic image/three-dimensional point cloud correspondence point estimation unit 50 will be described with reference to FIG. 3. FIG. 3 is a block diagram illustrating a functional configuration of the three-dimensional position estimation device 10 including the photographic image/three-dimensional point cloud correspondence point estimation unit 50 according to the first configuration example. Hereinafter, only the photographic image/three-dimensional point cloud correspondence point estimation unit 50 will be described.

The photographic image/three-dimensional point cloud correspondence point estimation unit 50 according to the first configuration example estimates a three-dimensional coordinate position of a correspondence pixel with the three-dimensional point cloud as a starting point. Therefore, the photographic image/three-dimensional point cloud correspondence point estimation unit 50 performs processing of projecting the three-dimensional point cloud into the virtual camera image and estimating the results.

The photographic image/three-dimensional point cloud correspondence point estimation unit 50 according to the first configuration example includes a point cloud identification ID assignment unit 51, a hidden point removal unit 52 that removes hidden points from a virtual camera viewpoint, a virtual camera image generation unit 53, a virtual camera image/image feature correspondence point estimation unit 54, and a three-dimensional point cloud/image feature correspondence point estimation unit 56. Furthermore, the virtual camera image/image feature correspondence point estimation unit 54 includes an optimum correspondence point determination unit 55.

The point cloud identification ID assignment unit 51 assigns a point cloud identification ID to each point of the three-dimensional point cloud received from the three-dimensional point cloud information acquisition unit 30 and records a three-dimensional point cloud coordinate position.

The hidden point removal unit 52 that removes hidden points from a virtual camera viewpoint determines and removes points (hidden points) that should not be originally visible from the virtual camera viewpoint.

The virtual camera image generation unit 53 projects the three-dimensional point cloud using the camera model and information regarding external parameters and internal parameters for the camera to generate a virtual camera image. The virtual camera image is a virtual image, and a pixel of the virtual camera image can be said to be a virtual pixel.

Therefore, hereinafter, the pixel of the virtual camera image is referred to as a virtual pixel.

The virtual camera image/image feature correspondence point estimation unit 54 applies the same two-dimensional screen coordinate system as that of the photographic image to the virtual camera image, and associates a pixel of the two-dimensional screen coordinate system of the photographic image with a pixel of the two-dimensional screen coordinate system of the virtual camera image at the same position as that of the pixel of the two-dimensional screen coordinate system of the photographic image. Thus, the virtual camera image/image feature correspondence point estimation unit 54 estimates the correspondence points of the virtual camera image with respect to the image feature points of the photographic image.

The optimum correspondence point determination unit 55 determines optimum correspondence points from a plurality of point clouds in order to reduce erroneous association between the virtual pixel of the virtual camera image and the pixel of the photographic image by the virtual camera image/image feature correspondence point estimation unit 54.

The three-dimensional point cloud/image feature correspondence point estimation unit 56 estimates the three-dimensional positions of the correspondence points of the three-dimensional point cloud with respect to the image feature points of the photographic image. Furthermore, the three-dimensional point cloud/image feature correspondence point estimation unit 56 associates the image features of the photographic image with the information of the three-dimensional positions of the estimated correspondence points. Thus, the three-dimensional positions of the image features of the photographic image are estimated.

### (Operation Example of Photographic Image/Three-Dimensional Point Cloud Correspondence Point Estimation Unit 50 According to First Configuration Example)

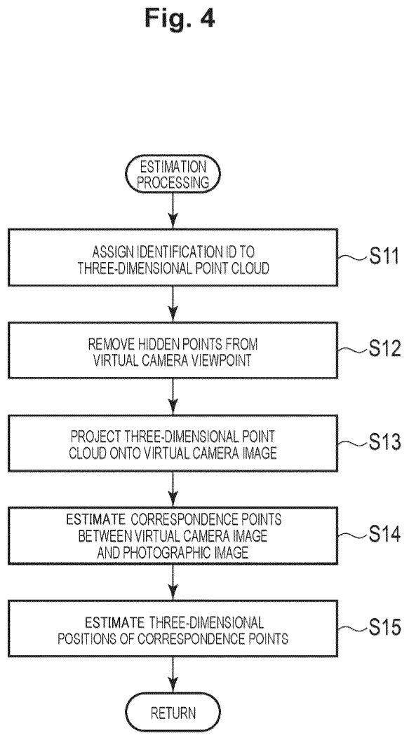

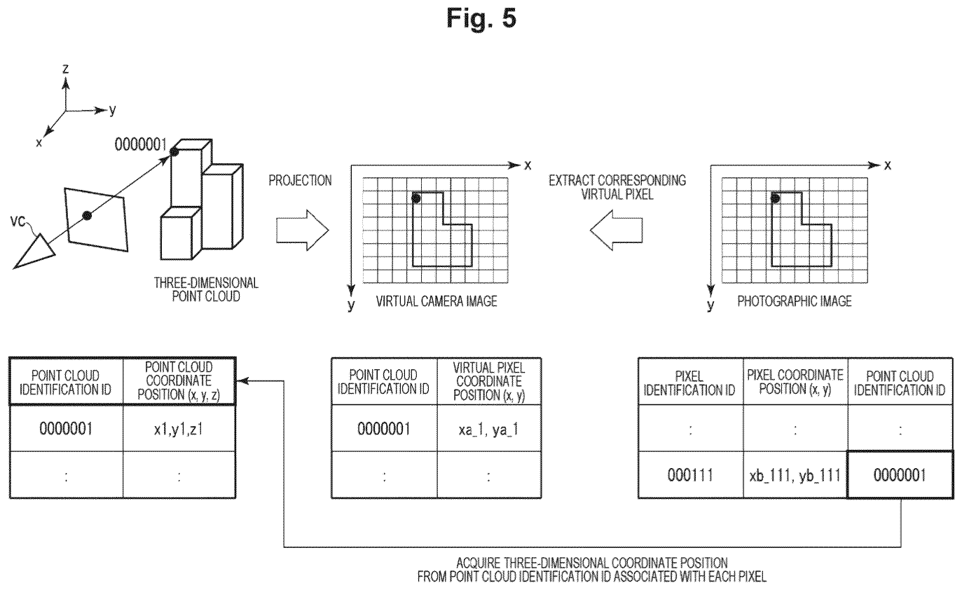

Next, processing executed by the photographic image/three-dimensional point cloud correspondence point estimation unit 50 according to the first configuration example will be described with reference to FIGS. 4 and 5. FIG. 4 is a subflowchart illustrating a flow of processing of estimating the correspondence points between the photographic image and the three-dimensional point cloud by the photographic image/three-dimensional point cloud correspondence point estimation unit 50 according to the first configuration example. FIG. 5 is a diagram schematically illustrating the processing of estimating the correspondence points between the photographic image and the three-dimensional point cloud by the photographic image/three-dimensional point cloud correspondence point estimation unit 50 according to the first configuration example.

In step S11, as illustrated in the left side of FIG. 5, the point cloud identification ID assignment unit 51 assigns a point cloud identification ID to each point of the three-dimensional point cloud and records a three-dimensional point cloud coordinate position (x, y, z). For example, the point cloud identification ID assignment unit 51 records a point cloud identification ID (000001) and a three-dimensional point cloud coordinate position (x1, y1, z1) for one point of the three-dimensional point cloud. The same processing is performed on each point of the three-dimensional point cloud to obtain a data set of the point cloud identification ID and the three-dimensional point cloud coordinate position (x, y, z).

In step S12, the hidden point removal unit 52 that removes hidden points from a virtual camera viewpoint in a virtual camera vc performs processing of determining and removing points (hidden points) that should not be originally visible from the virtual camera viewpoint. The processing of removing the hidden points from the virtual camera viewpoint will be described later.

In step S13, as illustrated in the center of FIG. 5, the virtual camera image generation unit 53 projects the three-dimensional point cloud onto the virtual camera image using information regarding the external parameters and internal parameters for the camera to generate a virtual camera image. At this time, the coordinate position is updated without changing the point cloud identification ID. For example, the virtual camera image generation unit 53 changes the three-dimensional point cloud coordinate position (x1, y1, z1) to a virtual pixel coordinate position (xa_1, ya_1).

The projection is performed on the basis of the camera model, the internal parameters, and the external parameters by general image processing.

In step S14, as illustrated in the center of FIG. 5, the virtual camera image/image feature correspondence point estimation unit 54 applies the same two-dimensional screen coordinate system as that of the photographic image illustrated on the right side of FIG. 5 to the virtual camera image. Furthermore, the virtual camera image/image feature correspondence point estimation unit 54 associates a pixel of the two-dimensional screen coordinate system of the photographic image with a virtual pixel of the two-dimensional screen coordinate system of the virtual camera image at the same position as that of the pixel of the two-dimensional screen coordinate system of the photographic image. Thus, the virtual camera image/image feature correspondence point estimation unit 54 estimates the correspondence points of the virtual camera image with respect to the image feature points of the photographic image.

Therefore, as illustrated on the right side of FIG. 5, the virtual camera image/image feature correspondence point estimation unit 54 assigns a pixel identification ID to each pixel of the photographic image and records a two-dimensional pixel coordinate position. For example, the virtual camera image/image feature correspondence point estimation unit 54 assigns a pixel identification ID (000111) to one pixel of the photographic image, and records a two-dimensional pixel coordinate position (xb_111, yb_111) of the pixel. In this example, the virtual pixel coordinate position (xa_1, ya_1) in the two-dimensional screen coordinate system of the virtual camera image matches a pixel coordinate position (xb_111, yb_1111) in the two-dimensional screen coordinate system of the photographic image. The virtual camera image/image feature correspondence point estimation unit 54 assigns the point cloud identification ID (000001) to a pixel with a pixel identification ID (000111) and a pixel coordinate position (xb_111, yb_1111).

In the above-described association processing, whether or not the association processing can be performed may be determined using RGB information of pixels of the photographic image and the virtual camera image or semantic information. That is, in a case where the RGB information is equal to or greater than a threshold or in a case where the semantic information is different, the pixels with the same coordinates are not associated with each other.

Note that the above-described association processing is only required to be performed only on the pixels at image feature points among the pixels of the photographic image.

Furthermore, in the above-described association processing, the optimum correspondence point determination unit 55 determines optimum correspondence points from a plurality of point clouds in order to reduce erroneous association between the virtual pixel of the virtual camera image and the pixel of the photographic image by the virtual camera image/image feature correspondence point estimation unit 54. The optimum correspondence point determination processing will be described later.

In step S15, the three-dimensional point cloud/image feature correspondence point estimation unit 56 estimates the three-dimensional positions of the correspondence points of the three-dimensional point cloud with respect to the image feature points of the photographic image.

For example, the three-dimensional point cloud/image feature correspondence point estimation unit 56 searches the data set of the point cloud identification ID and the three-dimensional point cloud coordinate position (x, y, z), which is obtained by the point cloud identification ID assignment unit 51, for the point cloud identification ID that matches the point cloud identification ID assigned to the pixel of the photographic image by the virtual camera image/image feature correspondence point estimation unit 54. The three-dimensional point cloud/image feature correspondence point estimation unit 56 associates the pixel at the image feature point of the photographic image with the same point cloud identification ID with the point cloud coordinate position (x, y, z) of the point of the three-dimensional point cloud. Thus, the three-dimensional positions of the correspondence points of the three-dimensional point cloud with respect to the image feature points of the photographic image are estimated.

Furthermore, the three-dimensional point cloud/image feature correspondence point estimation unit 56 associates the image features with the information of the three-dimensional positions of the estimated correspondence points. Thus, the three-dimensional positions of the image features are estimated.

### (Second Configuration Example of Photographic Image/Three-Dimensional Point Cloud Correspondence Point Estimation Unit 50)

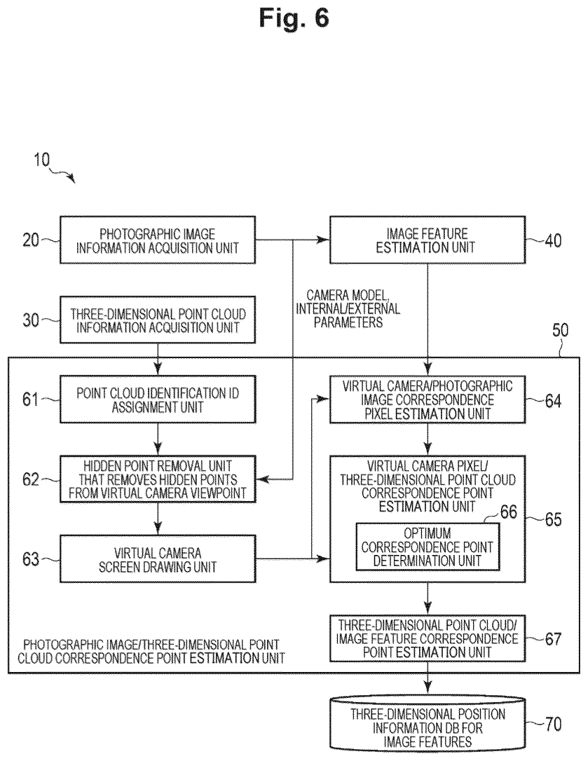

Next, a second configuration example of the photographic image/three-dimensional point cloud correspondence point estimation unit 50 will be described with reference to FIG. 6. FIG. 6 is a block diagram illustrating a functional configuration of the three-dimensional position estimation device 10 including the photographic image/three-dimensional point cloud correspondence point estimation unit 50 according to the second configuration example. Hereinafter, only the photographic image/three-dimensional point cloud correspondence point estimation unit 50 will be described.

The photographic image/three-dimensional point cloud correspondence point estimation unit 50 according to the second configuration example estimates the point cloud coordinate position of the point of the corresponding three-dimensional point cloud with a pixel of the photographic image as a starting point. Therefore, the screen (field of view) of the virtual camera is drawn and the estimation processing is performed.

The photographic image/three-dimensional point cloud correspondence point estimation unit 50 according to the second configuration example includes a point cloud identification ID assignment unit 61, a hidden point removal unit 62 that removes hidden points from a virtual camera viewpoint, a virtual camera screen drawing unit 63, a virtual camera/photographic image correspondence pixel estimation unit 64, a virtual camera pixel/three-dimensional point cloud correspondence point estimation unit 65, and a three-dimensional point cloud/image feature correspondence point estimation unit 67. Furthermore, the virtual camera pixel/three-dimensional point cloud correspondence point estimation unit 65 includes an optimum correspondence point determination unit 66.

The functions of the point cloud identification ID assignment unit 61, the hidden point removal unit 62 that removes hidden points from a virtual camera viewpoint, the optimum correspondence point determination unit 66, and the three-dimensional point cloud/image feature correspondence point estimation unit 67 in the photographic image/three-dimensional point cloud correspondence point estimation unit 50 according to the second configuration example are the same as the functions of the point cloud identification ID assignment unit 51, the hidden point removal unit 52 that removes hidden points from a virtual camera viewpoint, the optimum correspondence point determination unit 55, and the three-dimensional point cloud/image feature correspondence point estimation unit 56 in the photographic image/three-dimensional point cloud correspondence point estimation unit 50 according to the first configuration example, respectively.

Hereinafter, only the differences, that is, the virtual camera screen drawing unit 63, the virtual camera/photographic image correspondence pixel estimation unit 64, and the virtual camera pixel/three-dimensional point cloud correspondence point estimation unit 65 will be described.

The virtual camera screen drawing unit 63 generates a virtual camera on the three-dimensional point cloud space according to the camera model and internal parameters for the camera that captures the photographic image, installs the virtual camera according to the position and orientation as the external parameters of the camera, and draws a virtual camera screen showing the three-dimensional point cloud space with the virtual camera.

The virtual camera/photographic image correspondence pixel estimation unit 64 applies the same two-dimensional screen coordinate system as that of the photographic image to the virtual camera screen, and associates a pixel of the two-dimensional screen coordinate system of the photographic image with a pixel of the two-dimensional screen coordinate system of the virtual camera screen at the same position as that of the pixel of the two-dimensional screen coordinate system of the photographic image. Thus, the virtual camera/photographic image correspondence pixel estimation unit 64 estimates the correspondence pixel between the photographic image and the virtual camera screen.

The virtual camera pixel/three-dimensional point cloud correspondence point estimation unit 65 projects a straight line to each virtual pixel of the virtual camera screen from the camera lens position of the virtual camera, and extracts a point cloud on the straight line. Moreover, the virtual camera pixel/three-dimensional point cloud correspondence point estimation unit 65 associates the point cloud identification ID of the extracted point cloud with each virtual pixel of the virtual camera screen. Thus, each image feature point of the photographic image and the three-dimensional position of each point of the three-dimensional point cloud are associated with each other. That is, the three-dimensional positions of the image features of the photographic image are estimated.

### (Operation Example of Photographic Image/Three-Dimensional Point Cloud Correspondence Point Estimation Unit 50 According to Second Configuration Example)

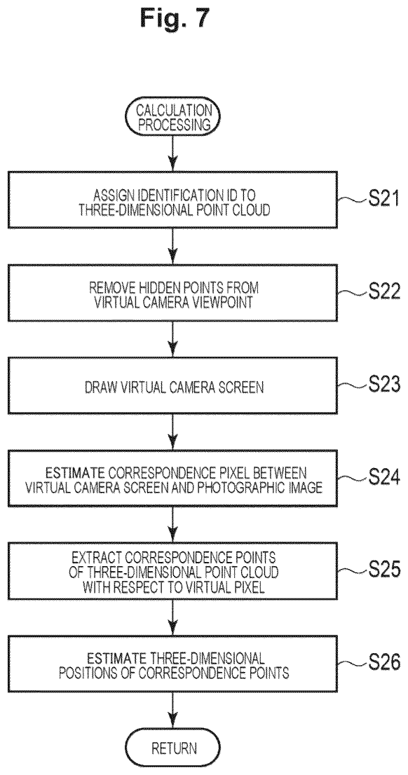

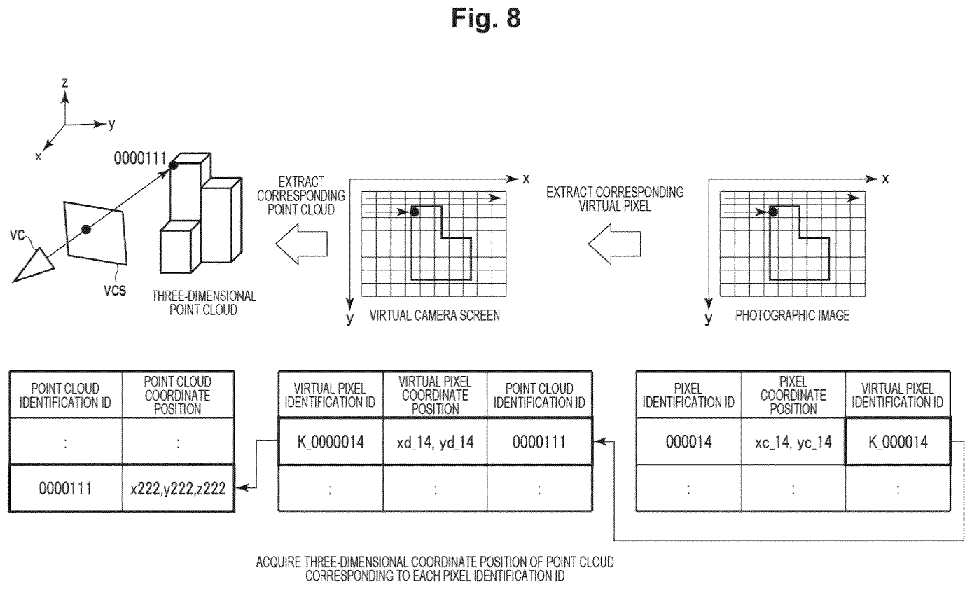

Next, processing executed by the photographic image/three-dimensional point cloud correspondence point estimation unit 50 according to the second configuration example will be described with reference to FIGS. 7 and 8. FIG. 7 is a subflowchart illustrating a flow of processing of estimating the correspondence points between the photographic image and the three-dimensional point cloud by the photographic image/three-dimensional point cloud correspondence point estimation unit 50 according to the second configuration example. FIG. 8 is a diagram schematically illustrating the processing of estimation the correspondence points between the photographic image and the three-dimensional point cloud by the photographic image/three-dimensional point cloud correspondence point estimation unit 50 according to the second configuration example.

In step S21, as illustrated in the left side of FIG. 8, the point cloud identification ID assignment unit 61 assigns the point cloud identification ID to each point of the three-dimensional point cloud and records a three-dimensional point cloud coordinate position (x, y, z). Thus, the data set of the point cloud identification ID and the three-dimensional point cloud coordinate position (x, y, z) are obtained.

In step S22, the hidden point removal unit 62 that removes hidden points from a virtual camera viewpoint in the virtual camera vc performs processing of determining and removing points (hidden points) that should not be originally visible from the virtual camera viewpoint. The processing of removing the hidden points from the virtual camera viewpoint will be described later.

In step S23, as illustrated on the left side of FIG. 8, the virtual camera screen drawing unit 63 generates the virtual camera vc on the three-dimensional point cloud space according to the internal parameters of the camera that captures the photographic image. Moreover, the virtual camera screen drawing unit 63 installs the virtual camera vc according to the position and orientation as the external parameters of the camera, and as illustrated in the center of FIG. 8, draws a virtual camera screen showing the three-dimensional point cloud space with the virtual camera.

In step S24, as illustrated in the center of FIG. 8, the virtual camera/photographic image correspondence pixel estimation unit 64 applies the same two-dimensional screen coordinate system as that of the photographic image illustrated on the right side of FIG. 8 to the virtual camera screen. Moreover, the virtual camera/photographic image correspondence pixel estimation unit 64 associates the pixel of the screen coordinate system of the photographic image with the virtual pixel of the screen coordinate system of the virtual camera screen at the same position as that of the pixel of the screen coordinate system of the photographic image. Thus, the virtual camera/photographic image correspondence pixel estimation unit 64 estimates the correspondence pixel between the virtual camera screen and the photographic image.

Therefore, as illustrated on the right side of FIG. 8, the virtual camera/photographic image correspondence pixel estimation unit 64 assigns the pixel identification ID to each pixel of the photographic image, records the two-dimensional pixel coordinate position, and assigns a virtual pixel identification ID. Furthermore, as illustrated in the center of FIG. 8, the virtual camera/photographic image correspondence pixel estimation unit 64 assigns the virtual pixel identification ID to each virtual pixel of the virtual camera screen, records the virtual pixel coordinate position, and assigns a point cloud identification ID.

For example, as illustrated on the right side of FIG. 8, the virtual camera/photographic image correspondence pixel estimation unit 64 assigns a pixel identification ID (000014) to one pixel of the photographic image, records a two-dimensional pixel coordinate position (xc_14, yc_14), and assigns a virtual pixel identification ID (K_000014). Furthermore, the virtual camera/photographic image correspondence pixel estimation unit 64 assigns the virtual pixel identification ID (K_000014) to the virtual pixel at the same position as that of the pixel with the pixel identification ID (000014), and records a two-dimensional virtual pixel coordinate position (xd_14, yd_14).

In step S25, the virtual camera pixel/three-dimensional point cloud correspondence point estimation unit 65 projects a straight line to each virtual pixel of a virtual camera screen vcs from the camera lens position of the virtual camera vc, and extracts a point cloud on the straight line. Moreover, the virtual camera pixel/three-dimensional point cloud correspondence point estimation unit 65 associates the point cloud identification ID of the extracted point cloud with each virtual pixel of the virtual camera screen vcs.

For example, as illustrated on the left side of FIG. 8, the virtual camera pixel/three-dimensional point cloud correspondence point estimation unit 65 projects a straight line passing through the two-dimensional virtual pixel coordinate position (xd_14, yd_14) on the virtual camera screen vcs of the virtual pixel identification ID (K_000014), and extracts a point cloud with a point cloud pixel identification ID (0000111) on the straight line. Furthermore, as illustrated in the center of FIG. 8, the virtual camera pixel/three-dimensional point cloud correspondence point estimation unit 65 assigns a point cloud identification ID (0000111) to the virtual pixel with the virtual pixel identification ID (K_000014).

In the above-described association processing, whether or not the association processing can be performed may be determined using RGB information of pixels of the photographic image and the virtual camera screen vcs or semantic information. That is, in a case where the RGB information is equal to or greater than a threshold or in a case where the semantic information is different, the pixels with the same coordinates are not associated with each other.

Note that the above-described association processing is only required to be performed only on the pixels at image feature points among the pixels of the photographic image.

Furthermore, in the above-described association processing, the optimum correspondence point determination unit 66 determines optimum correspondence points from a plurality of point clouds in order to reduce erroneous association between the virtual pixel of the virtual camera screen vcs and the pixel of the photographic image by the virtual camera pixel/three-dimensional point cloud correspondence point estimation unit 65. The optimum correspondence point determination processing will be described later.

In step S26, the three-dimensional point cloud/image feature correspondence point estimation unit 67 estimates the three-dimensional positions of the correspondence points of the three-dimensional point cloud with respect to the image feature points of the photographic image.

Therefore, the three-dimensional point cloud/image feature correspondence point estimation unit 67 searches the data set of the point cloud identification ID and the three-dimensional point cloud coordinate position (x, y, z), which is obtained by the point cloud identification ID assignment unit 61, for the point cloud identification ID of the point cloud extracted by the virtual camera pixel/three-dimensional point cloud correspondence point estimation unit 65. Thus, the three-dimensional point cloud/image feature correspondence point estimation unit 67 acquires the point cloud coordinate position (x, y, z) of the correspondence point in the three-dimensional point cloud of the pixel at the image feature point of the photographic image.

For example, the three-dimensional point cloud/image feature correspondence point estimation unit 67 searches the data set of the point cloud identification ID and the three-dimensional point cloud coordinate position (x, y, z), which is obtained by the point cloud identification ID assignment unit 61, for the point cloud identification ID (0000111), and acquires a three-dimensional point cloud coordinate position (x222, y222, z222) of the point cloud of the point cloud identification ID (0000111).

The three-dimensional point cloud/image feature correspondence point estimation unit 67 associates the point cloud coordinate position (x, y, z) of the point of the acquired three-dimensional point cloud with the pixel at the image feature point of the photographic image. Thus, the three-dimensional positions of the correspondence points of the three-dimensional point cloud with respect to the image feature points of the photographic image are estimated.

Furthermore, the three-dimensional point cloud/image feature correspondence point estimation unit 67 associates the image features with the information of the three-dimensional positions of the estimated correspondence points. Thus, the three-dimensional positions of the image features are estimated.

### (Optimum Correspondence Point Determination Processing)

In the photographic image/three-dimensional point cloud correspondence point estimation unit 50 according to the first configuration example, in a case where the resolution of the photographic image is low or the point group density of the three-dimensional point cloud is high, a plurality of points of the point cloud may be included in one virtual pixel of the two-dimensional screen coordinate system of the virtual camera image.

In the photographic image/three-dimensional point cloud correspondence point estimation unit 50 according to the second configuration example, in a case where the resolution of the photographic image is low or the point group density of the three-dimensional point cloud is high, a plurality of points of the point cloud may be included in one virtual pixel of the two-dimensional screen coordinate system of the virtual camera screen.

In any case, it is desirable to determine the optimum correspondence point from a plurality of points of the point cloud to reduce the erroneous association. Therefore, the optimum point is only required to be determined from a plurality of points of the point cloud using the attribute information (RGB information, semantic information, or the like) of the photographic image and the attribute information (three-dimensional coordinate position, RGB information, reflection intensity, semantic information, or the like) of the point cloud.

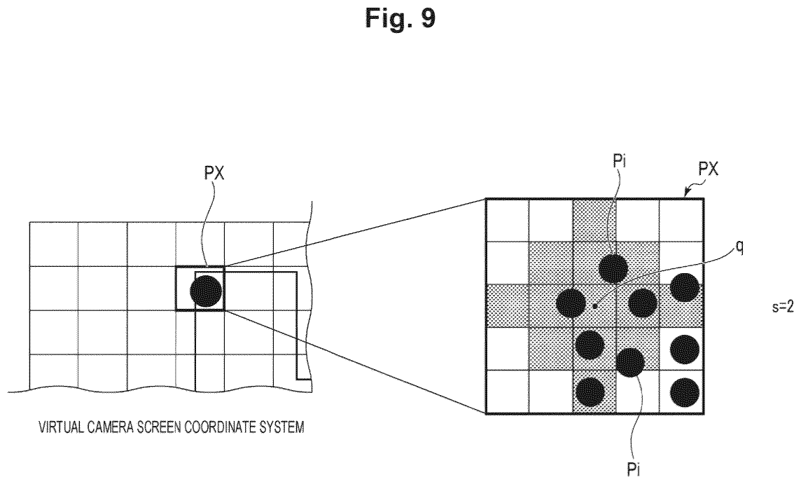

Hereinafter, with reference to FIG. 9, the optimum correspondence point determination processing for reducing the erroneous association of the pixels described above will be described. FIG. 9 is a diagram schematically illustrating the optimum correspondence point determination processing executed by the photographic image/three-dimensional point cloud correspondence point estimation unit 50. This optimum correspondence point determination processing is a method for extracting a plurality of arbitrary points close to a center position when one pixel of the two-dimensional screen coordinate system is subdivided, and selecting or newly generating an optimum correspondence point using the attribute information of each point.

N points pi (i=1, 2, . . . , N) at distances within a threshold s from a center position q when one pixel PX in the two-dimensional screen coordinate system is subdivided are extracted.

In a case where no point pi is extracted, it is determined that there is no correspondence point.

In a case where there is one extracted point pi, the point is selected as the correspondence point.

[Math. 1] In a case where a plurality of points pi are extracted, a new point \vec{m} is generated with the weighted average of the three-dimensional coordinate positions as a coordinate position using the attribute information of all points pi (three-dimensional coordinate positions, RGB information, reflection intensity, and the like), and point \vec{m}, is set as a correspondence point. The newly generated point \vec{m} is only required to have at least three-dimensional coordinate position information. The following is an example of the weighted average.
<Weighted average with distance t from center position q as weight>

$$\vec{m} = {\sum }_{i = 0}^{N - 1} \frac{{w}_{i}}{{\sum }_{i = 0}^{N - 1} {w}_{i}} {\vec{v}}_{i}$$

where, \vec{v}ᵢ is the three-dimensional position of each extracted point, and wᵢ is the weight of each point.

$${\vec{v}}_{i} = ( \begin{matrix}{x}_{i} \\ {y}_{i} \\ {z}_{i}\end{matrix} ) , {w}_{i} = \frac{1}{t + 1}$$

In addition, the RGB information of each point and the RGB information of each pixel of the photographic image may be used as weights. Furthermore, the three-dimensional coordinate position of each point may be referred to, and the number of points within a certain distance may be used as the weight.

Through the above-described processing, the optimum correspondence point can be selected or newly generated. Thus, it is possible to reduce the erroneous association between the pixel of the photographic image and the virtual pixel of the virtual camera image or the virtual camera screen.

(Processing of Removing Hidden Points from Virtual Camera Viewpoint)

In the photographic image/three-dimensional point cloud correspondence point estimation unit 50 according to the first configuration example, a point that should not be visible from the virtual camera is included in the virtual camera image when projection on the virtual camera image is performed.

In the photographic image/three-dimensional point cloud correspondence point estimation unit 50 according to the second configuration example, a point that should not be visible from the virtual camera is included in the virtual camera screen.

In any case, it is desirable to remove the points that should not be visible from the virtual camera and reduce the erroneous association.

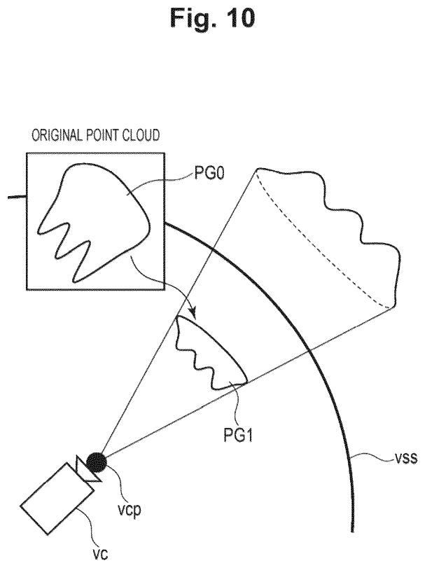

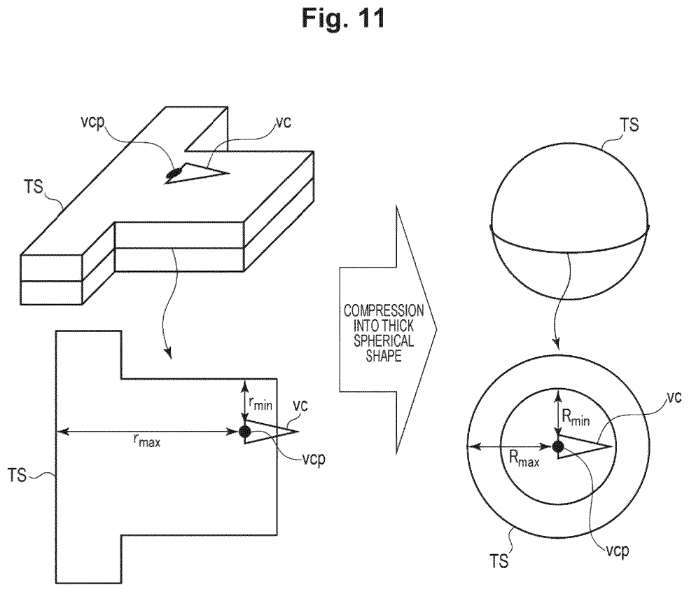

Hereinafter, with reference to FIGS. 10 and 11, the processing of removing the hidden points from the virtual camera viewpoint to reduce the erroneous association of the pixel described above will be described. FIGS. 10 and 11 are diagrams schematically illustrating the processing of removing the hidden points from the virtual camera viewpoint, which is executed by the photographic image/three-dimensional point cloud correspondence point estimation unit 50. The processing of removing the hidden points from the virtual camera viewpoint is a method for processing a three-dimensional point cloud in advance. This is to extend a method for removing points that should not be visible from the virtual camera vc to the target space.

For example, the portion invisible from the virtual camera viewpoint can be determined by meshing the point cloud. The point cloud can be meshed using a technology such as open3D or CloudCompare. However, it takes a lot of estimation time to mesh the point cloud. Therefore, here, an example of a method of not performing meshing will be described.

As a method for removing the points that should not be visible from the virtual camera, there are conventional technologies such as Direct visibility of point sets and Open3D Hidden Point Removal. Direct visibility of point sets is disclosed in Literature “S. Katz, A. Tal, and R. Basri, “Direct visibility of point sets”, ACM Transactions on Graphics Vol. 26, No. 3, Article 24”.

However, these conventional technologies are technologies for a point cloud of a desk or an object present in a space, and in a case where a space having a large depth is targeted, all point clouds at a certain distance or more from the virtual camera viewpoint position are removed. Hereinafter, a method for removing a portion invisible from the virtual camera viewpoint without this problem will be described.

First, as illustrated in FIG. 10, an original three-dimensional point cloud PG0 in the target space is scaled in the line-of-sight direction of the virtual camera vc so as to fall inside the virtual spherical surface vss, for example, so as to become a three-dimensional point cloud PG1. For example, as illustrated in FIG. 11, the three-dimensional point cloud in a target space TS is compressed into a thick spherical shape centered on a virtual camera viewpoint vcp. Thus, the target space TS can be treated as a spherical object. For example, the target space TS is compressed into a spherical shape as follows.

$${\vec{v}}_{i}^{′} = \frac{{R}_{max}}{{r}_{max}} \{ \vec{{v}_{l}} - ( {r}_{min} - {R}_{max} ) \vec{e} \} \qquad [ Math . 2 ]$$

where,
\vec{v}ₗ is the coordinate position of the original point cloud,
\vec{v}′ᵢ is the coordinate position of the compressed point cloud,
\vec{e} is a unit vector,
rₘᵢₙ is the distance to a point that is closest to the virtual camera viewpoint vcp in the original point cloud,
rₘₐₓ is the distance to a point that is farthest from the virtual camera viewpoint vcp in the original point cloud,
Rₘᵢₙ is the distance to a point that is closest to the virtual camera viewpoint vcp in the compressed point cloud,
Rₘₐₓ is the distance to a point that is farthest from the virtual camera viewpoint vcp in the compressed point cloud.

The ratio of removed viewpoints can be adjusted by tuning the shortest distance Rₘᵢₙ/the longest distance Rₘₐₓ from the center of the virtual camera viewpoint Vcp according to the size of the target space TS in the depth direction.

Furthermore, the compression ratio may be changed according to the distance from the virtual camera viewpoint vcp. The compression ratio can be changed using, for example, the following equation.

$${\vec{v}}_{i}^{′} = f ( \vec{{v}_{l}} ) \frac{{R}_{max}}{{r}_{max}} \{ \vec{{v}_{l}} — ( {r}_{min} — {R}_{max} ) \vec{e} \} \qquad [ Math . 3 ]$$

where, f(\vec{v}ₗ) is a function that takes \vec{v}ₗ as an argument and returns the compression ratio.

For example, by using a sigmoid function, compression can be performed such that the closer points are denser and the farther points are sparser.

The subsequent processing can be performed by treating the target space TS as a spherical object and using the above-described conventional technology of Direct visibility of point sets.

Through the series of processing, the points (hidden points) that should not be visible from the virtual camera vc can be removed. Thus, it is possible to reduce the erroneous association between the pixel of the photographic image and the virtual pixel of the virtual camera image or the virtual camera screen.

Note that, in the operation example of the photographic image/three-dimensional point cloud correspondence point estimation unit 50 described above, an example has been described in which both the optimum correspondence point determination processing and the processing of removing the hidden points from the virtual camera viewpoint are performed in order to reduce the erroneous association between the pixel of the photographic image and the virtual pixel of the virtual camera image or the virtual camera screen. However, only one of the optimum correspondence point determination processing and the processing of removing the hidden points from the virtual camera viewpoint may be performed.

### (Hardware Configuration)

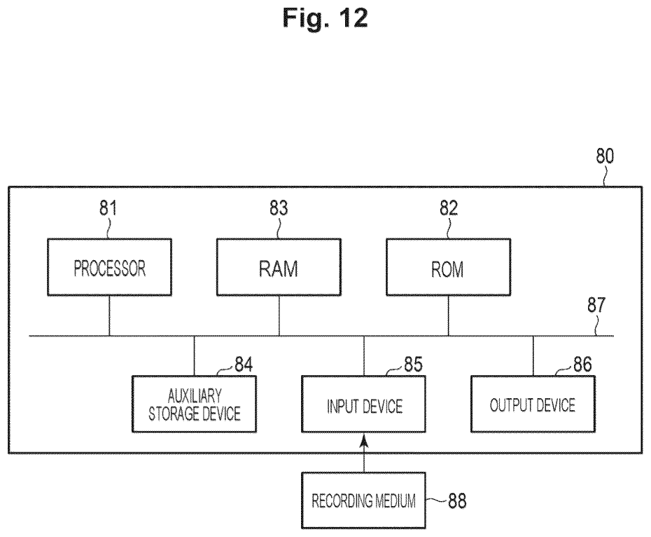

Next, a hardware configuration of the three-dimensional position estimation device 10 will be described with reference to FIG. 12. For example, the three-dimensional position estimation device 10 is configured with a computer 80. FIG. 12 is a block diagram illustrating the hardware configuration of the computer 80 constituting the three-dimensional position estimation device 10.

FIG. 2 illustrates the hardware configuration of the computer 80 constituting the three-dimensional position estimation device 10. The computer 80 includes a processor 81, a read only memory (ROM) 82, a random access memory (RAM) 83, an auxiliary storage device 84, an input device 85, and an output device 86.

The processor 81, the ROM 82, the RAM 83, the auxiliary storage device 84, the input device 85, and the output device 86 are electrically connected to each other via a bus 87, and can transmit and receive information to and from each other via the bus 87.

The processor 81 includes, for example, a general-purpose hardware processor including a central processing unit (CPU) and a graphical processing unit (GPU). The processor 81 entirely controls the ROM 82, the RAM 83, the auxiliary storage device 84, the input device 85, and the output device 86.

The ROM 82 is a nonvolatile memory constituting a part of a main storage device. The ROM 82 non-temporarily stores a startup program necessary for starting up the processor 81. The processor 81 is started by executing a program in the ROM 82. The ROM 82 includes, for example, an erasable programmable read only memory (EPROM), and stores various settings at the time of startup in addition to the startup program.

The RAM 83 is a volatile memory constituting a part of the main storage device. The RAM 83 temporarily stores a program necessary for processing by the processor 81 and data necessary for executing the program. The processor 81 calculates the data in the RAM 83 by executing the program in the RAM 83, and stores the calculation result in the RAM 83.

The auxiliary storage device 84 includes a nonvolatile memory such as a hard disk drive (HDD) or a solid state drive (SSD). The auxiliary storage device 84 non-temporarily stores a program executed by the processor 81 and data necessary for executing the program. The processor 81 loads the program and the data in the auxiliary storage device 84 into the RAM 83, and executes the program to execute various functions. Furthermore, the auxiliary storage device 84 constitutes the three-dimensional position information DB 70 for image features.

The input device 85 may include a keyboard, a mouse, a touch panel, a reception device, a disk drive, and an input port. The input device 85 is not limited thereto, and may include any other input devices. The output device 86 may include a display, a printer, a transmission device, a disk drive, and an output port. The output device 86 is not limited thereto, and may include any other output devices. The input device 85 and the output device 86 may be configured as an input/output device having both functions. The input/output device may include a touch panel, a transmission/reception device, a disk drive, and an input/output port. The reception device, the transmission device, and the transmission/reception device may function in a wired or wireless manner. Through the input device 85, the photographic image information is input to the photographic image information acquisition unit 20, and the three-dimensional point cloud information is input to the three-dimensional point cloud information acquisition unit 30.

The program non-temporarily stored in the auxiliary storage device 84 is provided to the computer 80 via, for example, a non-transitory computer-readable recording medium 88. The non-transitory computer-readable recording medium 88 includes a disk such as a flexible disk, an optical disk (CD-ROM, CD-R, DVD-ROM, DVD-R, or the like), or a magneto-optical disk (MO), and a semiconductor memory.

The program non-temporarily stored in the auxiliary storage device 84 includes a three-dimensional position estimation program. The three-dimensional position estimation program is a program that causes the computer 80 to execute at least some functions of the components of the three-dimensional position estimation device 10.

The program non-temporarily stored in the auxiliary storage device 84 is non-temporarily stored in the auxiliary storage device 84, for example, via a disk drive that is the input device 85 in a case where the non-transitory computer-readable recording medium 88 is a disk, or via an input port that is the input device 85 in a case where the non-transitory computer-readable recording medium 88 is a semiconductor memory. Furthermore, the program may be stored in a server on the network, downloaded from the server, and non-temporarily stored in the auxiliary storage device 84.

When the computer 80 is started up, the processor 81 executes the program in the ROM 82, loads an OS into the RAM 83, and starts the OS. The processor 81 monitors an instruction input, connection of an external device, and the like under the control of the OS. Furthermore, the processor 81 sets a program area and a data area in the RAM 83 under the control of the OS. In response to an instruction input to start the three-dimensional position estimation device 10, the processor 81 loads the three-dimensional position estimation program from the auxiliary storage device 84 into the program area of the RAM 83, and loads data necessary for execution of the three-dimensional position estimation program from the auxiliary storage device 84 into the data area of the RAM 83. The processor 81 calculates the data of the data area according to the three-dimensional position estimation program, and writes the calculation result in the data area. With such an operation, the processor 81, the RAM 83, and the auxiliary storage device 84 cooperate to execute at least some of the functions of the components of the three-dimensional position estimation device 10. For example, the processor 81, the RAM 83, and the auxiliary storage device 84 cooperate to execute the functions of the photographic image information acquisition unit 20, the three-dimensional point cloud information acquisition unit 30, the image feature estimation unit 40, and the photographic image/three-dimensional point cloud correspondence point estimation unit 50.

### (Effects)

According to the embodiment, the three-dimensional positions of the image features can be estimated from one photograph by combining one photograph of the target space and the three-dimensional point cloud space. Thus, the position and orientation of the object and the position and orientation of the imaging camera can be estimated. That is, a technology for estimating the three-dimensional positions of the image features without requiring two or more photographs is provided. In other words, since only one photograph is required to estimate the three-dimensional positions of the image features, it is possible to save the time and effort required to perform the imaging necessary for the estimation.

Note that the present invention is not limited to the above-described embodiment, and various modifications can be made in the implementation stage without departing from the gist of the invention. Furthermore, the embodiments may be implemented in appropriate combination, and in that case, a combined effect can be obtained. Moreover, the above-described embodiments include various inventions, and various inventions can be derived by combining the components selected from a plurality of disclosed components. For example, even in a case where some components are deleted from all the components shown in the embodiment, when the problem can be solved and the effect can be obtained, the configuration from which the components are deleted can be derived as the invention.

### REFERENCE SIGNS LIST

10 Three-dimensional position estimation device
20 Photographic image information acquisition unit
30 Three-dimensional point cloud information acquisition unit
40 Image feature estimation unit
50 Photographic image/three-dimensional point cloud correspondence point estimation unit
51 Point cloud identification ID assignment unit
52 Hidden point removal unit that removes hidden points from virtual camera viewpoint
53 Virtual camera image generation unit
54 Virtual camera image/image feature correspondence point estimation unit
55 Optimum correspondence point determination unit
56 Three-dimensional point cloud/image feature correspondence point estimation unit
61 Point cloud identification ID assignment unit
62 Hidden point removal unit that removes hidden points from virtual camera viewpoint
63 Virtual camera screen drawing unit
64 Virtual camera/photographic image correspondence pixel estimation unit
65 Virtual camera pixel/three-dimensional point cloud correspondence point estimation unit
66 Optimum correspondence point determination unit
67 Three-dimensional point cloud/image feature correspondence point estimation unit
70 Three-dimensional position information database for image features
80 Computer
81 Processor
82 ROM
83 RAM
84 Auxiliary storage device
85 Input device
86 Output device
87 Bus
88 Non-transitory computer-readable recording medium

1. A three dimensional position estimation device comprising processing circuitry configured to:
Receive, as inputs, photographic image information of one photographic image, image feature points of the photographic image, image features of the image feature points, and three dimensional point cloud information regarding a three dimensional point cloud related to the photographic image, and
estimate three dimensional positions of the image features, which are correspondence points of the three dimensional point cloud with respect to the image feature points, on a basis of the photographic image information, the image feature points, the image features, and the three dimensional point cloud information.

2. The three dimensional position estimation device according to claim 1,
wherein the processing circuitry is configured to:
generate a virtual camera image obtained by projecting the three dimensional point cloud, and
estimate the three dimensional positions of the correspondence points by estimating correspondence points between the virtual camera image and the photographic image.

3. The three dimensional position estimation device according to claim 1,
wherein the processing circuitry is configured to:
generate a virtual camera with a same position and orientation as a position and orientation of a camera that captures the photographic image in a three dimensional point cloud space, and draw a virtual camera screen showing the three dimensional point cloud space with the virtual camera,
estimate correspondence pixels of the photographic image and the virtual camera screen, and
estimate the three dimensional positions of the image features by estimating correspondence points of the three dimensional point cloud with respect to the photographic image on a basis of the correspondence pixels.

4. The three dimensional position estimation device according to claim 1,
wherein the processing circuitry is configured to generate a virtual image corresponding to the photographic image, and determine the correspondence points of the three dimensional point cloud with respect to the image feature points on a basis of a weighted average with respect to a plurality of points of a point cloud included in one pixel of the virtual image.

5. The three dimensional position estimation device according to claim 1,
wherein the processing circuitry is configured to generate a virtual camera in a three dimensional point cloud space related to the photographic image, and remove points that should not be visible from a viewpoint of the virtual camera on a basis of the three dimensional point cloud information.

6. A three dimensional position estimation method comprising:
receiving, as inputs, photographic image information of one photographic image, image feature points of the photographic image, image features of the image feature points, and three dimensional point cloud information regarding a three dimensional point cloud related to the photographic image;
generating a virtual camera image obtained by projecting the three dimensional point cloud onto the virtual camera image; and
estimating three dimensional positions of the image features, which are correspondence points of the three dimensional point cloud with respect to the image feature points by associating a pixel of the photographic image with a pixel of the virtual camera image at a same position as that of the pixel of the photographic image.

7. A three dimensional position estimation method comprising:
receiving, as inputs, photographic image information of one photographic image, image feature points of the photographic image, image features of the image feature points, and three dimensional point cloud information regarding a three dimensional point cloud related to the photographic image;
generating a virtual camera with a same position and orientation as a position and orientation of a camera that captures the photographic image in a three dimensional point cloud space, and drawing a virtual camera screen showing the three dimensional point cloud space with the virtual camera;
estimating correspondence pixels of the photographic image and the virtual camera screen; and
estimating three dimensional positions of the image features, which are correspondence points of the three dimensional point cloud with respect to the image feature points by estimating the correspondence points of the three dimensional point cloud with respect to the photographic image on a basis of the correspondence pixels.

8. A non-transitory storage medium storing a three dimensional position estimation program causing a computer including a processor and a storage device to execute at least some of functions of components of the three dimensional position estimation device according to claim 1.
